(19) United States
(12) Patent Application Publication
(10) Pub. No.: US 2012/0014055 A1
(43) Pub. Date: Jan. 19, 2012

(54) COMPUTER CASE WITH GUIDING PLATES FOR DRIVES

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/875,095

(22) Filed: Sep. 2, 2010

(30) Foreign Application Priority Data
Jul. 15, 2010 (CN) 201010223875.X

(51) Int. Cl. G06F 1/16

(52) U.S. Cl. 361/679.33

(57) ABSTRACT

An exemplary computer case includes an outer shell and a hard disk drive unit. The outer shell includes a top wall, a bottom wall, and sidewalls interconnected between the top and bottom walls. One of the sidewalls defines an opening therein. The hard disk drive unit includes a cage received in the outer shell and aligned with the opening. The cage is configured for holding hard disk drives therein. The cage includes guiding plates for guiding sliding of the hard disk drives into and out from the cage.

### BACKGROUND

1. Technical Field

The present disclosure relates to a computer case providing convenient installation of hard disk drives.

2. Description of Related Art

A personal computer frequently includes a case defining an opening at a lateral side, various data storage devices (for example, a hard disk drive, floppy disk, and CD-ROM drive, etc) disposed inside the case, and a side door fixed on the lateral side of the case for covering the opening of the case.

When the storage devices in the computer case need to be maintained or replaced, the side door must be detached, rendering these processes somewhat cumbersome and time-consuming.

It is thus desirable to provide a computer case which can overcome the described limitations.

### BRIEF DESCRIPTION OF THE DRAWINGS

FIG. 1 is an isometric, assembled view of a computer case according to an exemplary embodiment of the present disclosure.

FIG. 2 is an exploded view of the computer case of FIG. 1.

FIG. 3 is an isometric, exploded view of a hard disk drive unit of the computer case of FIG. 2.

FIG. 4 is similar to FIG. 3, but with the hard disk drive unit shown from another aspect.

FIG. 5 is a partly assembled view of the hard disk drive unit of FIG. 3.

FIG. 6 is similar to FIG. 1, but schematically showing installation of a hard disk drive into the computer case.

### DETAILED DESCRIPTION

Reference will now be made to the drawing figures to describe the present computer case in detail.

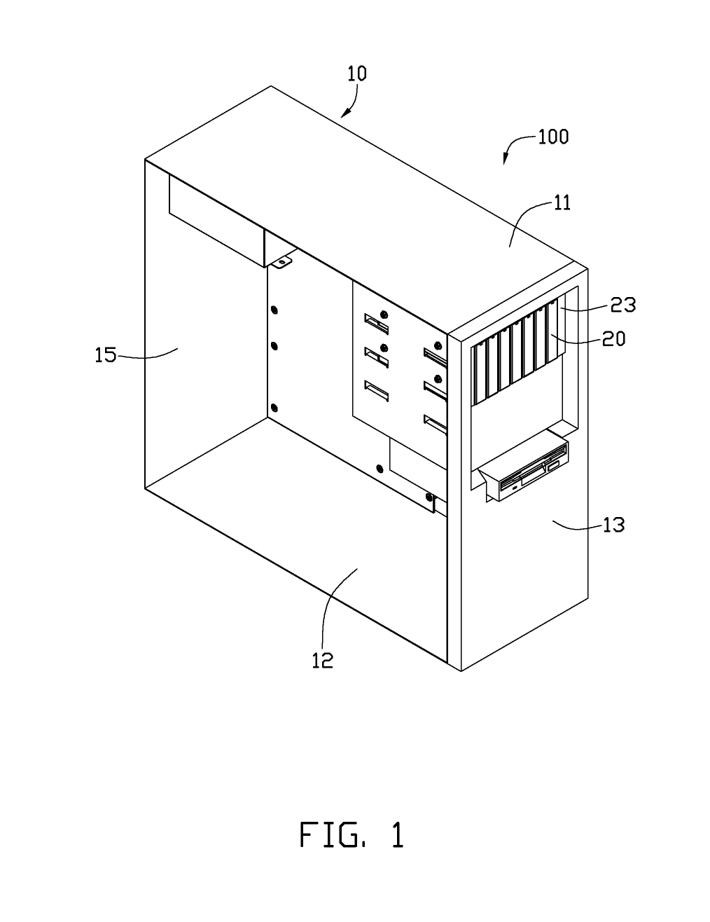

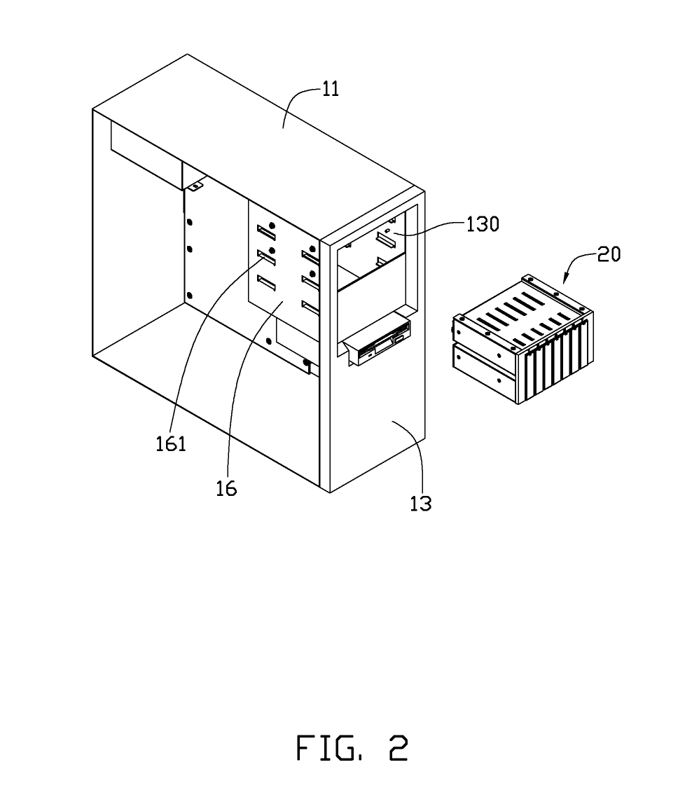

Referring to FIGS. 1 and 2, a computer case 100 according to an exemplary embodiment of the present disclosure is shown. The computer case 100 includes an outer shell 10, and a hard disk drive unit 20 received in the outer shell 10.

The outer shell 10 includes a top wall 11, a bottom wall 12 parallel to and apart from the top wall 11, and a plurality of sidewalls 13 interconnected between the top and bottom walls 11, 12. The top wall 11, the bottom wall 13 and the sidewalls 13 cooperatively define a cavity 15 for receiving various storage devices, such as a hard disk drive, and a CD-ROM drive (compact disk-read only memory drive) therein.

One of the sidewalls 13 at the front of the outer shell 10 defines a rectangular opening 130 at a top end thereof. A pair of fixing walls 16 respectively extends rearward from opposite edges of the front sidewall 13, at left and right sides of the opening 130, respectively. Each of the fixing walls 16 includes three pairs of fixing plates 161 extending perpendicularly therefrom. The fixing plates 161 on one fixing wall 16 extend towards the fixing plates 161 on the other fixing wall 16. A distance between each two neighboring pairs of fixing plates 161, one pair above the other, is substantially equal to a thickness of each CD-ROM drive. Each pair of fixing plates 161 is originally configured for supporting one CD-ROM drive thereon. In this embodiment, a space defined between the two fixing walls 16 is originally configured for accommodating three CD-ROM drives. A size of the opening 130 is substantially equal to a size of two CD-ROM drives stacked one on the other.

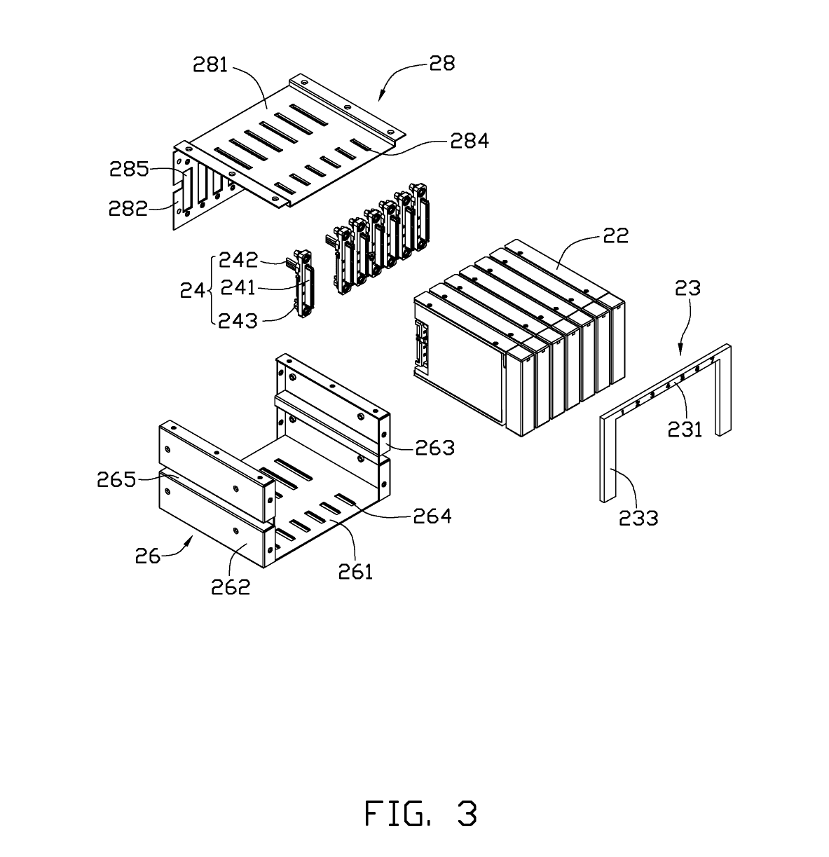

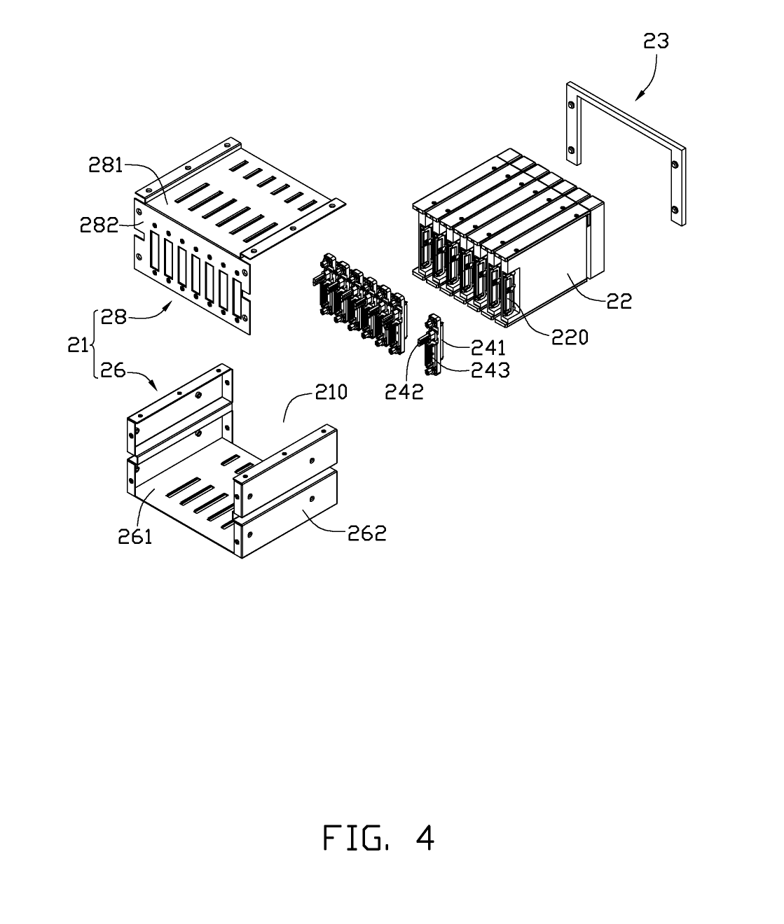

Referring also to FIGS. 3 and 4, the hard disk drive unit 20 includes a cage 21, a plurality of hard disk drives 22 received in the cage 21, a panel 23 mounted at the front of the cage 21 and a plurality of connectors 24 located at the back of the cage 21. Each of the hard disk drives 22 is a standard 2.5 inch-hard disk drive. Each of the hard disk drives 22 includes a socket 220 at the back thereof. The connectors 24 correspond to the hard disk drives 22, respectively. Each of the connectors 24 includes a data interface 241 at a first side, and a signal interface 242 and a power interface 243 at a second side opposite to the first side.

The cage 21 includes a base 26 and a cover 28. The base 26 is substantially U-shaped. The base 26 includes a rectangular bottom plate 261, and left and right plates 262, 263 extending up from left and right sides of the bottom plate 261, respectively. A plurality of first guiding plates 264 extends up from a top surface of the bottom plate 261. The first guiding plates 264 are equally spaced from each other along a lateral axis of the bottom plate 261. A distance between each two neighboring first guiding plates 264 is substantially equal to a thickness of each hard disk drive 22. A height of each of the left and right plates 262, 263 is substantially equal to a transverse width of each hard disk drive 22. A recess 265 is defined at a middle portion of each of the left and right side plates 262, 263. The recess 265 prevents interference between the cage 21 and the fixing walls 16 when the cage 21 is mounted between the fixing walls 16.

The cover 28 includes a top plate 281, and a back plate 282 depending from the back of the top plate 281. When the cover 28 is attached to the base 26, the top plate 281 is interconnected between top ends of the left and right side plates 262, 263 and faces the bottom plate 261. A plurality of second guiding plates 284 depends from a bottom surface of the top plate 281. The second guiding plates 284 and the first guiding plates 264 are aligned with each other. A plurality of perforations 285 is defined in the back plate 282. The perforations 285 are equally spaced from each other along a lateral axis of the back plate 282. The perforations 285 correspond to the connectors 24, respectively.

The panel 23 is substantially U-shaped, and includes an elongated name plate 231, and two decorative plates 233 respectively depending from two opposite ends of the name plate 231. A plurality of serial numbers which corresponds to the hard disk drives 22 are provided on the name plate 231. The panel 23 is mounted at the front of the cage 21, with the name plate 231 affixed to the front end of the top plate 281 and the decorative plates 233 affixed to front ends of the left and right side plates 262, 263, respectively. The panel 231 can enhance the appearance of the front side of the cage 21 exposed in the opening 130 when the cage 21 is mounted in the outer shell 10.

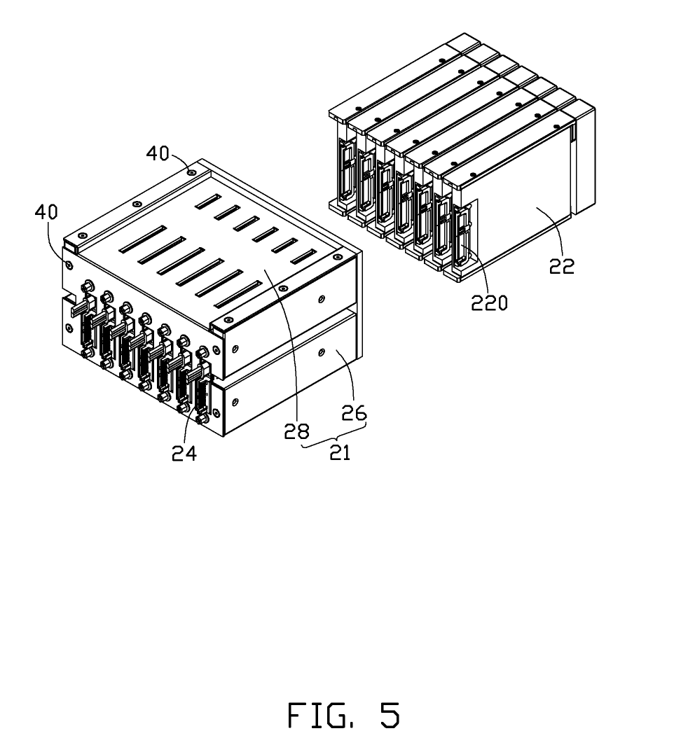

When the cage 21 is assembled, referring to FIG. 5, the top plate 281 of the cover 28 is interconnected between the top ends of the left and right side plates 262, 263 of the base 26, with left and right portions of the top plate 281 and the top ends of the left and right side plates 262, 263 fixed together by fasteners 40. The back plate 282 of the cover 28 is interconnected between the rear ends of the left and right side plates 262, 263 of the base 26, with left and right portions of the back plate 282 and the rear ends of the left and right side plates 262, 263 fixed together by fasteners 40. The base 26 and the cover 28 cooperatively define a receiving space 210 (see FIG. 4) for receiving the hard disk drives 22 therein. The connectors 24 are fixed on the back plate 282 and correspond to the perforations 285, respectively. Each of the connectors 24 extends through a corresponding perforation 285, with the data interface 241 protruding into the receiving space 210 and the signal interface 242 and the power interface 243 in the back of the cage 21.

When the cage 21 is attached to the outer shell 10, the cage 21 is firstly positioned at the front of the outer shell 10, with the left and right side plates 262, 263 aligned with the left and right peripheral sides of the opening 130, respectively. As the cage 21 moves rearward, the left and right side plates 262, 263 abut and slide along the two fixing plates 130, respectively, until the cage 21 is wholly received in the cavity 15 of the computer case 100. Then the left and right side plates 262, 263 of the cage 21 and the fixing plates 130 are fixed together via a plurality of fasteners 40.

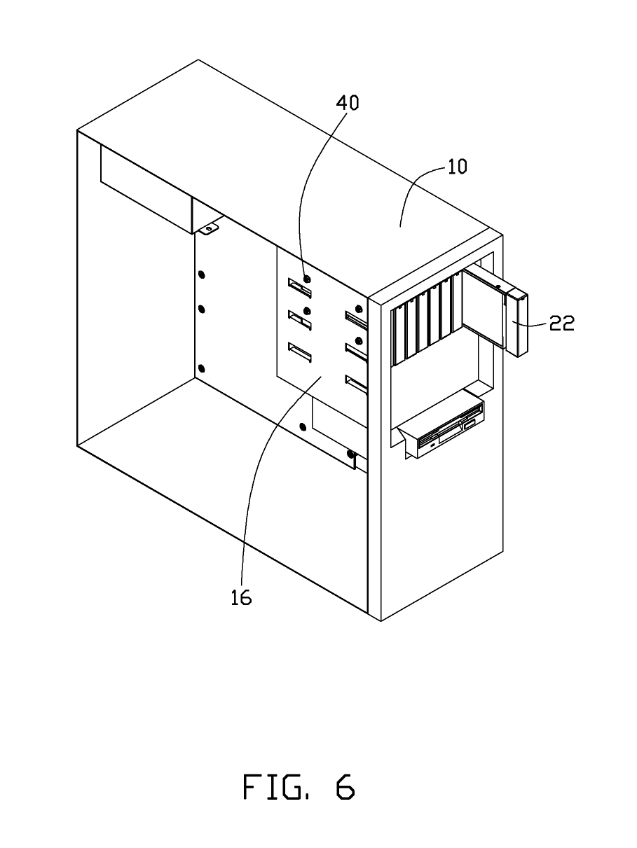

Referring to FIG. 6, assembly of one of the hard disk drives 22 to the cage 21 is shown. The hard disk drive 22 is placed on its side. Left and right sides of the top end of the hard disk drive 22 are aligned with a corresponding pair of second guiding plates 284, and left and right sides of a bottom end of the hard disk drive 22 are aligned with a corresponding pair of first guiding plates 264. As the hard disk drive 22 is slid rearward, the top and bottom ends of the hard disk drive 22 slide along the first and second pairs of guiding plates 264, 284, respectively, until the socket 220 of the hard disk drive 22 connects with the data interface 241 of the corresponding connector 24 mounted at the back plate 282 of the cage 21. In this state, the hard disk drive 22 is wholly received in the receiving space 210 of the cage 21. The hard disk drive 22 can also be conveniently withdrawn from the outer shell 10 by sliding the hard disk drive 22 along the first and second guiding plates 264, 284 of the cage 21 and out through the opening 130. Accordingly, the hard disk drives 22 can be inserted into or withdrawn from the cage 21 from the front of the computer case 100, increasing the convenience of installation and removal.

In the present disclosure, the hard disk drive unit 20 is mounted in a space of the computer case 100 originally configured for two CD-ROM drives, such that the computer case 100 does not have to be redesigned or remanufactured. Furthermore, the hard disk drive unit 20 can receive multiple hard disk drives 22 therein, so several hard disk drives 22 for different purposes can be swapped into and out from the hard disk drive unit 20.

It is to be understood, however, that even though numerous characteristics and advantages of the embodiment(s) have been set forth in the foregoing description, together with details of the structures and functions of the embodiment(s), the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer case comprising:
an outer shell comprising a top wall, a bottom wall, and a plurality of sidewalls interconnected between the top and bottom walls, one of the sidewalls defining an opening therein; and
a hard disk drive unit comprising a cage received in the outer shell and aligned with the opening, the cage configured for holding a plurality of hard disk drives therein, the cage comprising a plurality of guiding plates for guiding sliding of the hard disk drives into and out from the cage.

2. The computer case of claim 1, wherein the cage comprises a base for supporting the hard disk drives thereon, the base comprising a bottom plate and two side plates extending up from two opposite sides of the bottom plate, the guiding plates extending up from the bottom plate.

3. The computer case of claim 2, wherein the outer shell comprises two fixing walls located at two opposite sides of the opening, and wherein the two side plates of the base are fixed to the two fixing walls, respectively.

4. The computer case of claim 2, wherein the cage further comprises a cover attached to the base, the cover comprising a top plate interconnected between top ends of the two side plates and a side plate depending from one side of the top plate, the cage comprising another plurality of guiding plates aligned with the guiding plates of the bottom plate, respectively, depending from the top plate.

5. The computer case of claim 4, further comprising the plurality of hard disk drives, wherein the hard disk drive unit further comprises a plurality of connectors corresponding to the hard disk drives, respectively, each of the connectors comprising a data interface at a first side and a signal interface and a power interface at a second side opposite to the first side, the side plate of the cover defining a plurality of perforations for receiving the connector therein, respectively, and each of the hard disk drives comprising a socket at the back providing connection of the data interface of a corresponding connector.

6. The computer case of claim 5, wherein each of the hard disk drives is a standard 2.5 inch hard disk drive.

7. The computer case of claim 1, wherein the opening is defined in a top end of the sidewall at the front of the computer case, and corresponds to two compact disk-read only memory (CD-ROM) drives of the computer case.

8. The computer case of claim 7, wherein the hard disk drive unit is mounted in a space of the outer shell originally configured for receiving two CD-ROM drives therein.

9. A computer case comprising:
an outer shell defining an opening at one side thereof, the opening corresponding to a space of the outer shell capable of receiving two compact disk-read only memory (CD-ROM) drives therein; and
a hard disk drive unit comprising:
a cage received in the space of the outer shell; and
a plurality of hard disk drives received in the cage, the cage aligned with the opening and the cage comprising a plurality of guiding plates structured and arranged for the hard disk drives to be received in and withdrawn from the cage via the opening by sliding the hard disk drives along the guiding plates.

10. The computer case of claim 9, wherein the cage comprises a base for supporting the hard disk drives thereon, the base comprising a bottom plate and two side plates extending up from two opposite sides of the bottom plate, the guiding plates extending up from the bottom plate.

11. The computer case of claim 10, wherein the outer shell comprises two fixing walls located at two opposite sides of the opening, and wherein the two side plates of the base are fixed to the two fixing walls, respectively.

12. The computer case of claim 10, wherein the cage further comprises a cover attached to the base, the cover comprising a top plate interconnected between top ends of the two side plates and a side plate depending from one side of the top plate, the cage comprising another plurality of guiding plates aligned with the guiding plates of the bottom plate, respectively, depending from the top plate.

13. The computer case of claim 12, wherein the hard disk drive unit further comprises a plurality of connectors corresponding to the hard disk drives, respectively, each of the connectors comprising a data interface at a first side and a signal interface and a power interface at second side opposite to the first side, the side plate of the cover defining a plurality of perforations for receiving the connector therein, respectively, and each of the hard disk drives comprising a socket at the back providing connection of the data interface of a corresponding connector.

14. The computer case of claim 13, wherein each of the hard disk drives is a standard 2.5 inch hard disk drive.

15. The computer case of claim 12, wherein the hard disk drive unit further comprises a panel mounted a front of the cage, the panel comprising an elongated name plate and two decorative plates respectively depending from two opposite ends of the name plate, a plurality of serial numbers which corresponds to the hard disk drives being provided on the name plate.

16. The computer case of claim 15, wherein the name plate is affixed to front end of the top plate of the cover, and the decorative plates are affixed to front ends of two side plate of the base, respectively.

17. A computer case comprising:
a shell comprising a sidewall defining an opening therein; and
a cage received in the shell and exposed at the opening, the cage configured for holding a plurality of hard disk drives received therein, the cage comprising a plurality of pairs of guiding plates arranged parallel to each other, each pair of guiding plates comprising a first guiding plate for guiding sliding of a first side of a hard disk drive into and out from the cage and a second guiding plate for simultaneously guiding sliding of an opposite second side of the hard disk drive into and out from the cage.
